(19) United States
(12) Patent Application Publication
(10) Pub. No.: US 2006/0124810 A1
(43) Pub. Date: Jun. 15, 2006

(54) Apparatus for leveling and method of using same

(76) Inventor: Peter J. Cotto, Houston, TX (US)

Correspondence Address: THE MATTHEWS FIRM, 2000 BERING DRIVE, SUITE 700, HOUSTON, TX, 77057, US

(21) Appl. No.: 11/009,564

(22) Filed: Dec. 10, 2004

(51) Int. Cl. F16M 11/24

(52) U.S. Cl. 248/188.4

(57) ABSTRACT

A device for leveling a desired object such as a cabinet or enclosure on uneven or sloping floors is provided. The device is comprised of a housing which may be attached to the object to be leveled, such as a cabinet wall either prior to, during, or after installation of the cabinet, enclosure, or other desired object. The housing is further provided with a threaded hole and a threaded member, which engages the threaded hole. When the treaded member is rotated, it will contact the uneven or sloping floor and can lift or lower the cabinet or enclosure as needed for leveling.

### TECHNICAL FIELD

This invention relates generally to a leveling device and more particularly to a leveling device for leveling prefabricated or custom cabinetry without the use of shims.

### BRIEF BACKGROUND OF THE INVENTION

The need to install and level objects on uneven or sloping floors has presented a long-standing problem, especially for various types of apparatuses including machines and appliances. Often floors are not plumb or perfectly flat, yet it is important that all the legs or supports of an object contact the floor to provide adequate support and to equally distribute the weight of the object. If all the legs do not contact the floor, many problems can develop. For example, the outer cabinet and frame of an apparatus may become distorted over time due to nonuniform weight support, thereby impairing the proper operation of the apparatus. Annoying “rocking” problems with an apparatus may also result where the legs do not all contact the floor. Moreover, installations that are not level may be aesthetically undesirable by the inability to match the heights of adjacent cabinets, other equipment, or work surfaces.

Installers and manufacturers have attempted to resolve the leveling problem by developing approaches to compensate for uneven and sloping floors. Where the height of apparatus legs is not adjustable, for example, one such approach used by installers has been to place shims or wedges made of a suitable material under the legs. Obviously, this technique has numerous drawbacks. First, the apparatus must be manually lifted while such shims are placed under the legs, thereby often requiring more than one installer. This situation also increases the potential risk of back or other physical injuries to the installers. Second, the shims are not permanently mounted to the apparatus legs and may shift over time or become completely dislodged.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers.

FIG. 1 illustrates an elevated pictorial view of a cabinet employing the leveling device according to the present invention;

FIG. 2 illustrates the leveling apparatus according to the present invention;

FIG. 3 illustrates an elevated pictorial closeup view of the embodiment illustrated in FIG. 1, according to the present invention;

FIG. 4 illustrates a top plane view of a plug for the access hole for the leveling device according to the present invention; and

FIG. 4A illustrates a side elevated view of the embodiment illustrated in FIG. 4 according to the present invention.

### DETAILED DESCRIPTION OF EMBODIMENTS OF THE INVENTION

Manufacturers have attempted to resolve the leveling problem with numerous design approaches. One technique which has been employed is to provide manually adjustable legs or supports, often referred to commercially as glides or levelers, under each corner of the apparatus's outer cabinet. This consists primarily of a threaded vertical rod which on one end is screwed into a female threaded coupling near the apparatus's corners. The rod typically has a pad or flattened base of some sort disposed on the opposite end which contacts the floor. The pad may also swivel or tilt relative to the longitudinal axis of the vertical rod. These manually adjustable supports, however, are still plagued by many of the problems encountered with the shim technique described above. For example, in many cases, the apparatus must be lifted manually to unload weight from the legs in order to rotate them and adjust their height. Furthermore, there is usually no way to access the rear legs for adjustment once the apparatus is slid into its final position because access is often not available from the rear or sides of the apparatus. This is particularly true of kitchen appliances and cabinets which are usually placed against a wall in the rear and have other equipment, cabinets, or a wall positioned against one or both sides of the apparatus or cabinet. The manually adjustable leg design is also cumbersome to use, involving a time consuming trial and error approach to leveling the apparatus on uneven floors. The apparatus must often be slid into and out of its final position numerous times while gradual adjustments are made to the otherwise inaccessible rear support legs in hopes of finding the proper height of each rear leg. Other approaches have included manually adjustable wheels or rollers for rear supports and rear leveling systems which adjustable from the front.

FIG. 1 illustrates the leveling apparatus 10 attached to an enclosure 30. It should be understood, by those in the art, that the leveling apparatus 10 may or may not actually comprise a bubble level to indicate exactly when an enclosure, cabinet, or other desired object 30 is level. In one embodiment, a separate level indicator may be required to assure that a particular cabinet 30 or cabinet surface is level. However, the leveling apparatus 10 is preferably utilized to position the attached enclosure, cabinet, or other desired object 30 so as to establish a level position with respect to some predetermined support surface or floor 7. It should be appreciated that enclosure 30 can be a variety of enclosures, such as cabinets, appliance stands, entertainment centers, computer stands, toy boxes, enclosures for clothing or household goods, appliances, appliance enclosures, and any variety of enclosures which may typically be set up against a wall or in a room for storage. It should be further appreciated that the leveling apparatus 10 may be used to level tables, various counter tops, shelves, and the like and in such applications the accessibility of the leveling apparatus 10 may be easier. It should be noted that this cabinetry, whether custom made or purchased in an assembled or semi-assembled state, can be installed into homes either during building, remodeling, or anytime someone wishes to install extra storage space. As described herein above, because floors 7 or support members for such enclosures or cabinets 30 are frequently unlevel, it is necessary to have a leveling device which preferably has easy access. Preferably, the leveling device 10 attaches as illustrated in FIG. 1 around or to a bottom edge or rim 32 of the enclosure or cabinet 30. However, the leveling apparatus 10 may also be configured to mount to any support surface. The leveling apparatus 10 is preferably installed prior to completing the assembly of the cabinets or enclosures 30, and still more preferably, before the cabinet or enclosure 30 is set in its right side up position. Thus, the leveling apparatus 10 is easily installed. It should be understood that when cabinetry, particularly custom made cabinetry is installed, there is no access from the outside or facia boards to the leveling apparatus 10. Therefore, preferably leveling apparatus 10 is accessed through the sub-floor or bottom shelf 12 of cabinet 30. Preferably, and as illustrated in FIG. 1, leveling apparatus 10 is installed around or near the corners of the cabinet or enclosure 30. It should be appreciated by those in the art that when cabinets or enclosure 30 are considerably longer than they are wide, leveling supports 10 placed along the longitudinal side of enclosure 30, would be spaced as required to maintain a level of enclosure 30. Preferably, leveling apparatus 10 can be accessed through the sub-floor or bottom shelf 12 through a series of holes 14 drilled through the sub-floor or shelf 12 providing access to the top 17 (see FIG. 3) of leveling apparatus 10. It should be understood by those in the art how to form the holes 14 above the leveling apparatus 10, and as such, will not be described further herein.

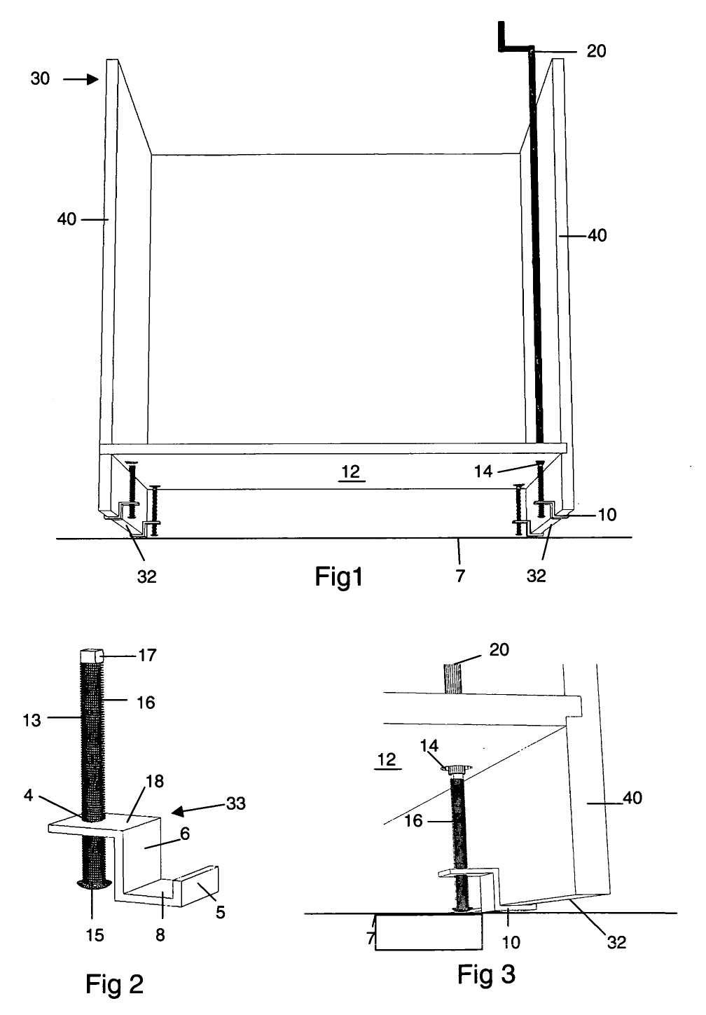

FIG.2 illustrates an embodiment of the leveling apparatus 10. Preferably, the leveling apparatus 10 comprises a threaded member 13. It should be appreciated that although the preferred embodiment utilizes a threaded member 13 to move the attached enclosure, table, or other desired object 30, member 13 can be moved utilizing other than threaded means such as those similar to a conventional jack, a ratchet system, modified threads, actuation, or a variety of means which would allow member 13 to raise or lower enclosure or object 30. Threaded member 13 preferably has a bottom end 15, and a top end 17. Preferably, top end 17 shall have a square cross-sectional shape or hexagonal cross-sectional shape so as to allow the attachment of a wrench or socket type tool that can be used for turning threaded member 13 in a clockwise or counterclockwise direction. It should be appreciated, by those in the art, that the shape of the top end 17 can be of a variety of cross-sectional configurations, including square hexagonal, or other polygonal shapes. It can also have a recessed top, allowing access to a hex wrench, torx wrench, or other similar device. It can also have a top configured for accepting crosshead or flathead screwdrivers, or be configured to accept any type of tool that can access the threaded member 13 and cause it to rotate. It should be further appreciated that the bottom end 15 preferably has a substantially flat area to allow contact with whatever structure is supporting the cabinet or enclosure 30 such as but not limited to floor or support surface 7 (see FIGS. 1 and 3). It should be noted, however that the exact configuration of the bottom end 15 could vary depending upon the structure upon which it rests, such as bottom end 15 may be substantially larger for a very rough area, or perhaps for certain types of carpeted areas. It should be further noted that the bottom end 15 can also have a protective covering or coating so as to prevent damage, such as scratching or gouging, from the bottom end 15 and any flooring 7 that may be supporting cabinet 30.

It should be appreciated that threaded member 13 could be configured having a variety of bottom end supports. For example, not intended as limiting, the end 15 may pass through the threaded hole 4 and then spread providing a different type of support to the leveling apparatus 10. It should be further appreciated that such a configuration of bottom end 15 may allow leveling of a cabinet or enclosure, which has shifted or moved after instillation, for reasons such as, but not limited to the shifting of a house or other structure or land. Thus, the cabinet or enclosure 30 can be leveled without substantial reconstruction.

Referring again to FIG. 2, preferably, threaded member 13 is inserted into a clip member 33. Preferably, clip member 33 is configured so as to attach to a bottom end 32 of cabinet or enclosure 30. Thus, a preferred embodiment may comprise a channel 8 which is at least partially enclosed by upright wall 6 and upright wall 5. It should be appreciated that channel 8 must be of the width sufficient to fit on cabinet wall end 32, and may need to be sized for specific applications. However, it should be understood that cabinetry will typically be constructed of certain thicknesses of wood, plywood, fiberboard, etc. Therefore, the size of channel 8 will preferably match typical cabinet wood thicknesses. As illustrated in FIG. 2, another member 18 is attached substantially perpendicular to channel wall 6. Plate 18 preferably has a hole 4 formed substantially in the center of plate 18. Preferably, hole 4 is internally threaded (not shown) in such a manner as to accept the thread 16 of threaded member 13. Thus, as threaded member 13 is rotated in either a clockwise or counterclockwise direction, threaded member 13 shall advance upward or downward through hole 4. It should be understood that although the embodiment illustrated herein shows the clip member 33 as being one piece, the clip member 33 may comprise the individual components, plate 18, the upright walls 5, 6, and the channel 8, which may be attached together in a variety of ways such as, but not limited to, welding, bolting, riveting, screwing, gluing, and other suitable attachment means.

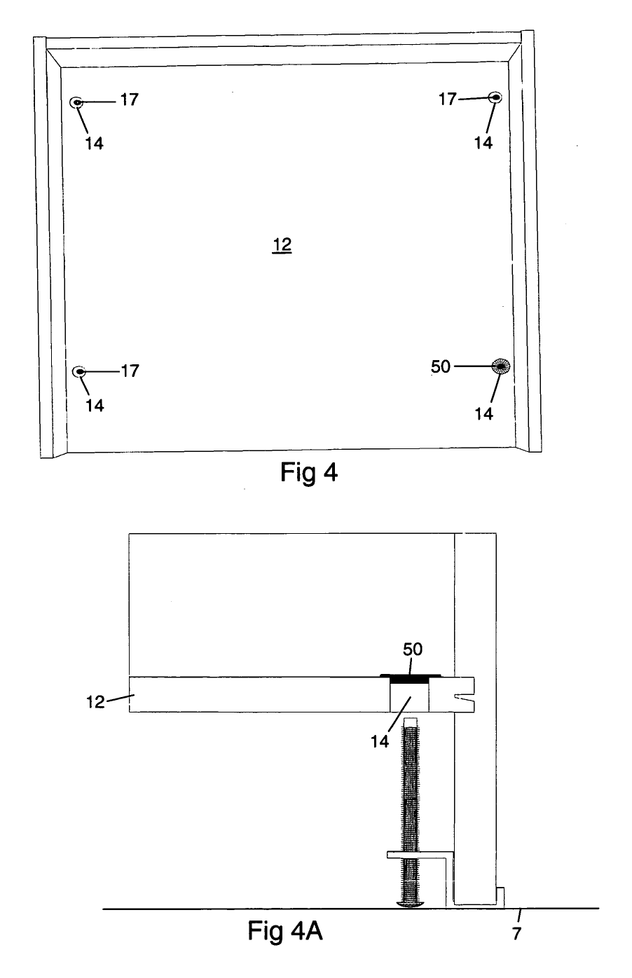

Referring now to FIG. 3, leveling apparatus 10 is attached to cabinet or enclosure 30 with bottom wall end 32 set into channel 8. The leveling apparatus 10 is further positioned such that the threaded member 13 is aligned with hole 14 formed in lower shelf or cabinet sub-floor 12. It should be appreciated that threaded member 13 preferably does not extend through hole 14 into the interior of cabinet or enclosure 30. Thus, preventing any interference between threaded member 13 and any objects which may be stored in cabinet or enclosure 30. Hole 14 may be left open or may be capped from the interior of enclosure 30. It should be appreciated that the capping of hole 14 may be through the use of a plug or cover which is configured to fit on or into hole 14. It should be further appreciated that cover or plug 50 (see FIG. 4) may be of any suitable material and color which would preferably blend in well with cabinet or enclosure 30.

In operation, leveling apparatus 10 is preferably installed when individual cabinet units or walls can either be put in an upside down position or be easily lifted for insertion of cabinet bottom end 32 into channel 8. In a typical installation, four of the leveling apparatuses 10 should be installed in the four corners, however as described herein above, different geometric shapes of cabinetry may require more or less leveling apparatus 10. However, regardless of the number of apparatuses 10 installed, each leveling apparatus 10 should be installed interior to the space formed by cabinet walls 40 and bottom shelf or sub-floor 12 (i.e., underneath shelf 12). After the leveling apparatus 10 has been attached to the bottom side 32 cabinet wall 40, hole 14 should be drilled in sub-floor or bottom shelf 12, as illustrated in FIGS. 1 and 3, directly above the threaded member 13. The hole 14 shall be of a diameter sufficient to allow the passing of a tool which would be able to rotate threaded member 13. After the cabinet has been placed in an upright position and/or leveling apparatuses 10 have been attached and hole 14 has been drilled, the cabinetry may be leveled. It should be appreciated that hole 14 may be pre-drilled in the bottom shelf of sub-floor 12 prior to the installation of the leveling apparatus 10. In such a case, it is obvious, to those skilled in the art, that the leveling apparatus 10 must be aligned so as to provide access to top end 17 (FIG. 2) through the hole 14. FIGS. 2 and 3 illustrate a leveling tool 20 which may access threaded member 13. However, it should be appreciated that leveling tool 20 is preferably used in the fabrication or construction stage of the cabinetry and may not be configured for access when cabinets are either pre-manufactured or have been previously installed. Preferably, each leveling apparatus 10 is accessible by a rotational tool and threaded member 13 can be turned in a clockwise or counterclockwise direction to extend or retract bottom end 15 towards or away from the support 7 upon which cabinet or enclosure 30 is set. It should be well known in the industry the exact technique of leveling the cabinets so that the surfaces are substantially level to prevent spillage or dropping of any objects placed upon such cabinet 30 and such leveling techniques will not be detailed herein. After each leveling apparatus 10 has been set in a preferred position, thus leveling the cabinetry 30, the cabinetry 30 can then be either more permanently attached to the support structure or to a wall, or may be left as desired. It should be noted that if the cabinetry is not permanently attached to the structure which supports said wall or other surrounding structure, the leveling apparatuses can be utilized at later dates to maintain levelness of cabinetry 30 regardless or other structure movement or settling. However, even if more permanently attached future detachment will allow the use of the leveling apparatus 10.

It should be appreciated that other alternative embodiments of the leveling apparatus are envisioned which are clearly within the scope of the present invention. For example, not intended as limiting, an embodiment may be attached to a cabinet or enclosure that has previously been installed. Thus, an embodiment could be modified for use in a retrofit situation. The attachment clip 33 could be modified, so as to allow attachment of the leveling apparatus of 10 to the inside of a wall 40. Preferably, plate 18 will still comprises threaded hole 4, however through which threaded member 13 may pass. However, wall 6 preferably extends in a perpendicular direction and away from the cabinet 30 support or floor 7. Preferably, wall 6 will have one or more holes formed through plate 6 for attachment to cabinet wall 40. The leveling apparatus 10, is then preferably attached so as to align threaded member 13 with hole 14, which is formed in bottom shelf or sub-floor 12. After leveling device 10 has been attached to wall 40, threaded member 13 can be turned, by applying a rotational tool to top end 17, and allow threaded member to advance through threaded hole 4 until contact is made with a surface or floor 7 supporting cabinet 30. Further turning of threaded member 17 can will preferably lift cabinet 30 and such described mounting and turning of other leveling apparatus 10, will allow the cabinet to be leveled.

It will be understood that certain features and sub-combinations are of utility and may be employed without reference to other features and sub-combinations. This is contemplated by and is within the scope of the claims. It may be seen from the preceding description that an apparatus for leveling has been provided. Although specific examples may have been described and disclosed, the invention of the instant application is considered to comprise and is intended to comprise any equivalent structure and may be constructed in many different ways to function and operate in the general manner as explained hereinbefore. Accordingly, it is noted that the embodiments described herein in detail for exemplary purposes are of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. An apparatus for establishing and/or maintaining a position of a desired object having a shape and edges comprising:
a clamp member adaptedly mounted with the desired object;
said clamp member comprising a first arm having a threaded opening, a second arm aligned with said first arm, a first transverse member extending between said first arm and said second arm, and a gripping piece extending transverse from said second arm and attached to said second arm at a position distal to said first transverse member, wherein said first transverse member, said second arm, and said gripping piece form a channel to accept a bottom edge of the desired object;
a threaded member engaged with said threaded opening of said first arm; and
said threaded member having a top end and a bottom end, wherein said bottom end is configured to contact a support surface, and wherein said top end is configured to be rotated, rotation of said threaded member will cause the desired object to move towards or away from the support surface for positioning as desired.

2. The apparatus of claim 1, wherein the top end has a top cross-section substantially polygonal shaped.

3. The apparatus of claim 1, wherein the top end has a shape configured to accept a screwdriver.

4. A method for positioning a desired object comprising the steps of:
attaching an apparatus for establishing and/or maintaining a position to a desired object and/or to a support surface, wherein the apparatus positions the desired object;
providing access from the desired object to the apparatus;
engaging the apparatus through said access, wherein said engagement operates the apparatus; and
operating the apparatus to increase or decrease the distance between the desired object and a support surface.

5. The method of claim 4, wherein the step of engaging comprises inserting a rotationally capable tool through said access.

6. The method of claim 4, wherein the step of attaching the apparatus further includes attaching the apparatus to an interior surface of the desired object.

7. The method of claim 4, further comprising the step of capping the access to the apparatus.

8. The method of claim 4, further comprising the step of affixing said desired object to surrounding supports after positioning said desired object.

9. An apparatus for establishing and/or maintaining a position of a desired object comprising:
an first member, wherein said first member is configured to be mounted to the desired object and/or to a support surface;
said first member capable of engaging a second member; and
said second member having a two ends, wherein one end is configured to contact the support surface, and wherein the other end is configured for operational engagement, whereby said operational engagement of said second member will cause said second member to extend or retract towards or away from the support surface, thus positioning at least part of the desired object where desired.

10. The apparatus of claim 9, wherein said position of the desired object is such that the desired object is level with respect to a predetermined axis.

11. The apparatus of claim 9, wherein said first member is mounted near a bottom side of the desired object.

12. The apparatus of claim 9, wherein the end configured for operational engagement is configured to be rotated.

13. The apparatus of claim 9, wherein said first member further comprises a first wall and a second wall, forming a channel therein, wherein said channel is configured to accept a bottom edge of the desired object.

14. The apparatus of claim 9, wherein the end configured for operational engagement has a substantially square shaped cross-section.

15. The apparatus of claim 9, wherein the end configured for operational engagement has a top cross-section substantially polygonal shaped.

16. The apparatus of claim 9, wherein the end configured for operational engagement has a shape configured to accept a crosshead screwdriver.

17. The apparatus of claim 9, wherein the end configured for operational engagement has a shape configured to accept a flathead screwdriver.

18. The apparatus of claim 9, wherein the end configured for operational engagement has a shape configured to accept a hexagonal tool.

19. The apparatus of claim 9, wherein the end configured for operational engagement has a shape configured to accept a torx head tool.

20. The apparatus of claim 9, wherein said first member comprises a first flange member and a second flange member mounted substantially transverse to said first flange member and wherein, said second flange member may be mounted to the desired object.
